(19) United States
(12) Patent Application Publication
(10) Pub. No.: US 2010/0098872 A1
(43) Pub. Date: Apr. 22, 2010

(54) MULTILAYERED MEMBRANE AND THE METHOD OF PRODUCING THE MEMBRANE

(76) Inventors: Gilbert Erskine, Lonsdale (AU); Jeff Norton, Lonsdale (AU); Craig Erskine, Lonsdale (AU)

Correspondence Address: WEINER & BURT, P.C., 635 N US-23, POB 186, HARRISVILLE, MI, 48740, US

(21) Appl. No.: 12/516,841

(22) PCT Filed: Jun. 13, 2007
(86) PCT No.: PCT/AU07/00825

§ 371 Date: Oct. 20, 2009

(30) Foreign Application Priority Data
Nov. 29, 2006 (AU) 2006906676

(51) Int. Cl. C08J 7/18; B01D 69/02

(52) U.S. Cl. 427/512; 427/205

(57) ABSTRACT

The present invention relates to the production of filter membranes (10) and in particular to multilayered filters. The invention related to a method of producing a filter membrane (10) wherein at least two layers (12, 14) are sequentially built upon a forming member (18) such that, when the forming member (18) is removed, the resultant membrane (10) includes a plurality of apertures extending therethrough, and at least some of said apertures increase in cross-sectional area from a first surface of the membrane to a second surface of the membrane. The method of production reduces the risk of permanent plugging from particulates being trapped within the membrane itself and has strong bonds between the layers which reduce the risk of separation of the layers. The present method produces an even coverage of the forming member (18) which in turn results in a layer of uniform thickness. The layer can be controlled by changing the viscosity of the mixture into which the former (18) is dipped.

### FIELD OF THE INVENTION

The present invention relates to the production of membranes and in particular to multilayered filter membranes for use in filtering liquids. The invention will be described with reference to metallic filter membranes for use in the wine industry, however, it will be appreciated that the invention is not limited to this particular field of use.

### BACKGROUND OF THE INVENTION

Filter membranes are used in numerous industries to separate particulates from fluid. The membranes can be constructed from various materials depending on their application, including plastic mesh, fine plastic tubes, porcelain or stainless steel mesh.

The viticulture industry utilises filters in the production of wine. Wine is passed through filters at various times during production, such as prior to maturation and after aging of the wine. This filtration is undertaken to remove impurities such as detritus and bacteria from the wine body.

Many currently available filters, such as the conventional fine plastic tubes, are prone to blockage. The configuration of the fine plastic tubes means that any blockage can result in putrefaction of the impurities which in turn leads to a reduction in wine quality due to the impartation of undesirable flavour characteristics.

Recently stainless steel mesh has been put forward as a replacement to conventional filters. The advantage with this material is that it is easy to clean and more robust than porcelain which can have a tendency to shatter under high pressure. However present methods of producing stainless steel filters suffer from a number of drawbacks, including the fact that it is difficult to produce a pore size within the mesh to adequately filter small particles. Furthermore, it is difficult to produce a mesh with evenly spaced pores, which can limit the effective open area of the mesh.

Membranes or indeed any other type of filtration media is purely a barrier to prevent the movement of particulates such as detritus and bacteria. In theory, a membrane with single channel pore would be an ideal filter. This is not however commercially viable. What actually occurs in filters, such as porcelain and metal filters, is that the fluid is forced along a torturous path from the retentate side of the membrane to the permeate side. In the process particulate material and bacteria is filtered out of the liquid. This has several disadvantages, for instance since there is a higher transmembrane pressure drop, there is risk of permanent plugging from particulates being trapped within the membrane itself which makes it harder to clean.

In order to minimize these disadvantages and reduce the effects of permanent plugging, manufactures have attempted to perfect the use of a thin layer on the inside or outside of the filter wall. These filters include an outer support tube produced with varying grades of metallic powder. This outer tube is fired and a thin coat is applied to either the internal or external surface using a much finer powder and the filter is then re-fired. One of the problems is that the layers can tend to laminate or separate due to the two step firing process.

It is therefore an object of the present invention to provide for a method of producing filter membranes and in particular metallic filter membranes which overcome at least some of the aforementioned problems or provide the public with a useful alternative.

It is yet a further object of the present invention to provide a method of producing a multilayered filter membrane which has strong bonds between the layers.

### SUMMARY OF THE INVENTION

Therefore in one form of the invention there is proposed a method of producing a filter membrane wherein at least two layers are sequentially built upon a forming member such that, when the forming member is removed, the resultant membrane includes a plurality of apertures extending therethrough, and at least some of said apertures increase in cross-sectional area from a first surface of the membrane to a second surface of the membrane.

Preferably at least one of said layers is formed by partially submersing the forming member into a mixture containing, in part, metallic particulate.

In preference the mixture includes a base material such as N-metal, priodyne, ethylene, and glycol or similar. The mixture further includes a metal base powder, such as but not limited to, stainless steel, tungsten, silica, boron, cobalt, chromium, nickel, and/or silver nitride.

More preferably the mixture is blended into homogenous consistency at a constant temperature and then heated to a temperature ranging from 38° C. to 110° C. The mixture is constantly stirred for a period of between 2 and 24 hours.

Preferably the mixture includes a methanol based solution which includes 1000 ml of denatured alcohol, 10 grams to 20 grams of Teflon, 7 grams of wax, 2 ml to 9 ml of glycerine and 2 m to 7 ml of polyethylene glycol, which is mixed with a metallic powder to produce a mixture having a paint-like constancy.

In preference the forming member is immersed in a sequence of different mixtures to form a plurality of layers. The different mixtures contain particles of different grain size and melting points.

Preferably the forming member comprises a chromed and highly polished rod with a diameter of between 4 mm and 300 mm.

In preference a charge is applied to the forming member to assist in the formation of said at least two layers.

In a further form of the invention there is proposed a method of producing a multilayered filter membrane, including the steps of:

a) providing a rod, which is adapted to act as a forming member onto which the membrane is built;

b) immersing at least a portion of the rod in a first mixture containing a first particulate and a methanol based solution, whereby a coating is formed;

c) removing the rod from the first mixture and allowing it to drip in a controlled atmosphere for a first pre-determined period of time;

d) immersing the rod into a liquid and allowing the rod to stand for a second pre-determined period of time;

e) allowing the rod to stand for a third predetermined period of time;

f) drying the rod;

g) placing the rod into a sheath such that a the rod is separated from the sheath by a cavity;

h) filling the cavity with a second mixture containing a second particulate;

i) sealing the ends of the sheath;

j) placing the sheathed rod into a press and applying a known pressure to the rod and coating thereby forming a cast;

k) separating the cast from the rod; and

l) treatment of the cast to thereby form a metallic filter membrane.

In preference steps b) to f) are repeated at least twice before pressing.

Preferably the treatment involves sintering the cast in a furnace.

In preference the first pre-determined time period is in the range from 5 seconds to 3 minutes, the second pre-determined time period is in the range from 30 seconds to 3 minutes and the third pre-determined time period is in the range between 3 seconds and 1 hour.

Preferably the liquid is RO water which is kept at a constant temperature.

In preference the rod is dried, either by air or infrared radiation.

Preferably the press is an isostatic press.

In preference the applied pressure is between 15,000 psi and 45,000 psi.

Preferably the rod which is partially encased by the cast or coating assembly is left under pressure for up to 1 hrs. The cast is the separated from the rod by withdrawing the rod out from within the cast assembly.

In yet a further form of the invention there is proposed a filter membrane produce using one of the above methods.

### BRIEF DESCRIPTION OF THE DRAWINGS

The accompanying drawings, which are incorporated in and constitute a part of this specification, illustrate several implementations of the invention and, together with the description, serve to explain the advantages and principles of the invention. In the drawings,

FIG. 1 is a perspective view of a first embodiment of a filter membrane produced using the method of the present invention; and

FIG. 2 is a stylised representation of a method of producing the filter membrane of FIG. 1.

### DESCRIPTION OF THE PREFERRED EMBODIMENTS

The following detailed description of the invention refers to the accompanying drawing. Although the description includes exemplary embodiments, other embodiments are possible, and changes may be made to the embodiments described without departing from the spirit and scope of the invention. Wherever possible, the same reference numbers will be used throughout the drawing and the following description to refer to the same and like parts.

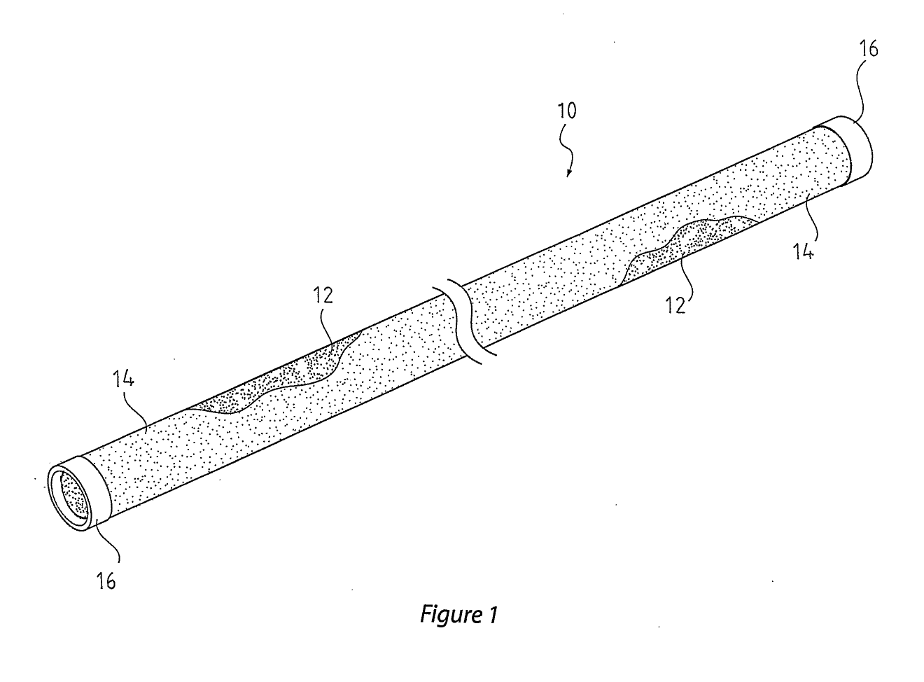

The present invention relates to the production of a filter membrane 10, as illustrated in FIG. 1, having at least a first inner layer 12 and an outer layer 14. The membrane 10 is fashioned in cylinder portions typically having an internal diameter of between 4 mm and 300 mm. The cylinder portions include terminal portions 16 formed of substantially nonporous material to enable a plurality of membrane portions to be welded in series.

The filter membrane 10, formed using the method of the present invention, has apertures that increase in cross-sectional area as the apertures extend from one side of the membrane to the opposing side. This increase in the cross-sectional area as the apertures is produced by having a plurality of layers formed using material of increasing grain or particle size. Accordingly, the metallic powder having the smallest grain size is used in the layer which is configured to be in direct contact with the unfiltered solution. The invention provides a method of, in essence, building the membrane from the inside out.

The reader will appreciate that by building the membrane from the inside out, with powders having particles sizes that gradually increase, an aperture matrix is formed wherein the cross-sectional area of the apertures increase as the apertures extend from the inside surface of the tube to the outside surface. This reduces the risk of plugging, which in turn reduces power input to operate a filtering machine in which the metallic filter membrane 10 is housed.

The metallic filter membrane 10 is envisaged to be in the form of a cylinder having a wall thickness of typically 5 mm and an overall diameter of 10 to 20 mm. These dimensions can however be varied to suit different applications.

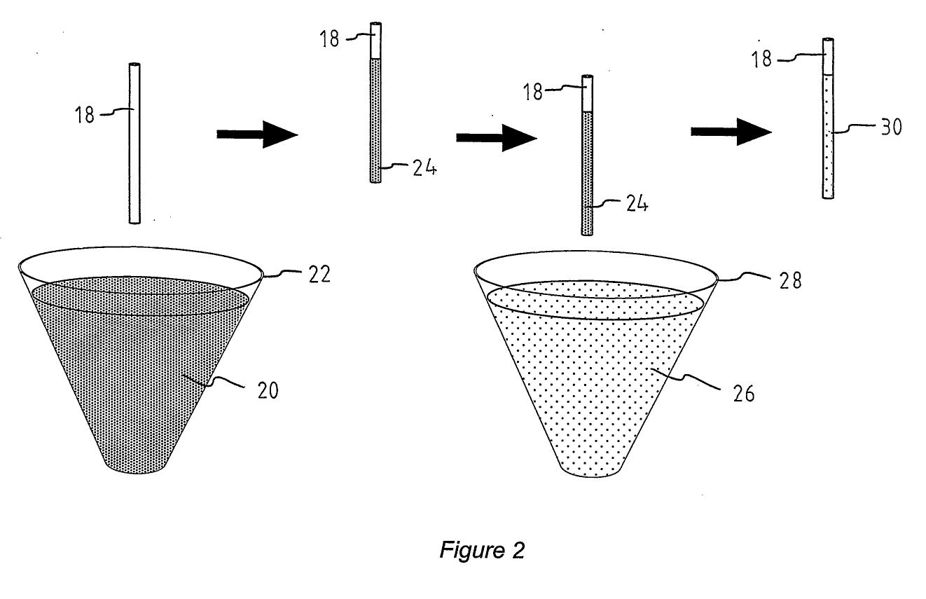

Referring to FIG. 2 for a more detailed description, there is illustrated a method of producing metallic filter membrane, demonstrating by way of example one arrangement in which the principles of the present invention may be employed.

The method uses a rod 18 which is adapted to act as a mandrill or former onto which a metallic filter membrane 10 is built. The rod 18 is constructed from highly polished chrome with a RA finish of 0.2 micron. It is envisaged that the diameter of the rod 18 will be between 4 mm and 300 mm depending upon the application for which the metallic filter membrane 10 will be used.

The rod 18 is then partially immersed in a first mixture 20 contained within vessel 22. The first mixture 20 is prepared by mixing three to eight micron of stainless steel 316L powder with five micron nickel powder, to a ratio of 70% to 90% stainless powder and 10% to 30% nickel powder. The use of nickel powder in the present invention is optional and is dependent upon the application. For example, certain types of nickel have charge related sites, which can be useful when filtering materials containing colloidal or protein. Nickel is also resistant to corrosion which is helpful when the filter is intended for used in corrosive environments.

The powder mix is added to a methanol based solution made up from 1000 ml of denatured alcohol, 10 grams to 20 grams of Teflon, 7 grams to 23 grams of wax, 2 ml to 9 ml of glycerine, 2 ml to 7 ml of polyethyleneglycol and mixed to produce a paint-like consistency.

The reader should appreciate that the use of Teflon and wax are dependent upon the type of membrane required and are not always included.

After a period of time the rod 18 is removed from the first mixture 20 and allowed to drip in a controlled atmosphere for between 5 seconds to 3 minutes. This thereby forms a first layer 24 on the rod 18. The rod 18 is then immersed into reverse osmosis water, which is kept at a constant temperature, for between 30 seconds to 3 minutes. The rod 18 is then allowed to stand for between 3 seconds and 1 hour, and dried using either air or infrared radiation. The thickness of the first layer 24 is typically between 25 microns and 70 microns.

As further illustrated in FIG. 1, the rod 18, which includes a first layer 24, is then partially immersed into a second mixture 26 contained within a second vessel 28. In this way a second layer 30 is formed on the rod 18 which completely overlays the first layer 24.

The second mixture 26 is prepared by mixing five to fifteen micron stainless steel 316L powder with 10 micron nickel powder, to a ratio of 70% to 90% stainless steel powder and 10% to 30% nickel powder. The powder mix is added to a methanol based solution made up from 1000 ml of denatured alcohol, 3 grams to 8 grams of Teflon, 7 grams to 23 grams of wax, 2 ml to 9 ml of glycerine, 2 ml to 7 ml of polyethyleneglycol and is then mixed to produce a paint-like consistency.

After a period of time the rod 18 is removed from the second mixture 26 and allowed to drip in a controlled atmosphere for between 5 seconds to 3 minutes. The rod 18 is then immersed into reverse osmosis water at a constant temperature for between 30 seconds to 3 minutes. The rod 18, including first and second layers 24 and 30, is then allowed to stand for between 3 seconds and 1 hour, and dried using either air or infrared radiation. The thickness of the second layer 30 is between 25 microns and 70 microns.

As the reader will appreciate the different mixtures 20 and 26 contain metallic particles of different grain size and different melting points. In particular the particles contained within the first mixture 20 are smaller than the particles contained within the second mixture 26.

By using powders having different melting points the extrusion is able to be sintered without running the risk of shutting off of the membrane. The skilled addressee would appreciate that if all the powders had the same melting point then the fine powder in the thin inner layer would merge into the thicker outer layer, since the thinner layer would melt first. This would effectively produce a solid inner surface thereby rendering the membrane useless. Therefore it is envisaged that the powder used in the inner layer would have a smaller particle size and higher melting point than the powder used in the outer layer. Accordingly, by controlling both the particle size of the powder and its melting point a multilayered membrane can be produced.

Although only two mixtures are described the skilled addressee will appreciate that numerous mixtures with sequentially larger particles could be used. In this way a multilayered cast is formed on rod 18.

The mixtures 20 and 26 include a base material such as N-metal, priodyne, ethylene, glycol or similar. The mixtures 20 and 26 further include metal base powders, such as but not limited to, stainless steel, tungsten, nickel, silica, boron, cobalt, chromium, and/or silver nitride. Preferably the stainless steel is of varying grades and sizes depending upon the desired mixture. In this way the open area of the membrane can be controlled.

To ensure regular pore spacing the mixtures are kept in a homogenous state at a constant temperature. Preferably the mixtures are heated to a temperature ranging from 38° C. to 110° C., and during production are constantly stirred for a period of between 2 and 24 hours.

The rod 18, with layers or coatings 24 and 30, is then placed inside a polyurethane sheath such that a space or gap is present between the external surface of the coated rod and the sheath. It is envisaged that the polyurethane sheath has a density of between 70 and 90 shore.

A course mixture is then prepared using thirty to eighty micron stainless powder mixed with 40 micron nickel, to a ratio of between 70% to 90% stainless powder and 10% to 30% nickel powder. The nickel is however optional. This course mixture is then used to fill the gap between the polyurethane sheath and the coated rod. This course mixture forms the structural layer of the metallic filter membrane 10.

The ends of the sheath are then sealed and the assembly, including rod 18, layers 24, 30, structural layer and sheath are placed into an isostatic press (not shown) and pressure is applied. Preferably the pressure that the press exerts on the assembly is between 15,000 psi and 45,000 psi. Single or multiple press functions may be applied. The assembly is then left under pressure for up to 1 hour.

The assembly is then removed from the press and the polyurethane sheath is peeled away to reveal the layered metal powders which have been compressed to a degree that allows them to be removed from the rod 18. The cast, or green compact as it is also known in the art, is separated from the rod by sliding the rod 18 out from within the cast. The highly polished surface of the rod 18 assists in minimising the resistance as the rod 18 is removed.

The cast is then placed in a controlled atmosphere furnace to sinter or fire the green compact thereby producing the metallic filter membrane 10. The furnace typically produces pressures of between 10 and −2 mbar and maximum temperatures ranging from 1180° C. and 1240° C. During the heating process back-fill gas is introduced. This gas is a combination of hydrogen/argon and nitrogen. The skilled addressee should however appreciate that the invention is not limited to these sintering conditions and the pressure, temperature and holding time can be varied depending on the type of membrane being produced.

The method of the present invention produces tubes of a set length which can be welded together to form a filter membrane of desired length. The use of the highly polished rod 18 produces a mirror finish on the internal surface of the filter membrane which reduces the risk of fouling and furthermore reduces turbulence during use in close proximity to the internal surface of the membrane.

The membrane 10 is tubular in construction with terminal portions 16 used to join membrane lengths together to form a desired length. The terminal portions 16 are joined by welding as is known in the art. It is envisaged that the terminal portions 16 are composed of standard 1.6 annealed tube. One end is swaged out by about 2 mm and is welded onto the membrane using an orbital tig welding process.

It is envisaged that stainless steel with be used however it should be appreciated that any other suitable material could be used. The powder can be selected from a group containing but not limited to metallic, non-metallic and inter-metallic materials.

The skilled addressee will now appreciate the many advantages of the present invention. The invention provides a method for producing membranes with varying micron ratings. The method eliminates laminating of the membrane, due to its unique method of manufacture which involves only a single firing step rather than two or more as in the prior art. The unique way of applying the different layers ensures that there is no mixing and means that regular pore spacing can be maintained. The resultant pore size can therefore be control depending upon the application for which the membrane is to be use. The present invention provides a means of controlling and varying the micron finish and to maintaining a consistent open area in the filter membrane.

The present invention also overcomes the difficulties associated with currently used spay methods which can result in uneven coverage or under/overspray. The present invention, whereby the former is dipped into a mixture, results in an even coverage. The thickness of the layer can also be controlled by changing the viscosity of the mixture into which the former is dipped.

Although it is envisaged that the present invention is directed towards the production of membrane in the 0.1 micron to 100 micron range the invention is not limited to this particular size range. Furthermore the term metallic membrane, or its equivalent, is used it should be appreciated that the term is in no way intended to limit the scope of the patent and other suitable materials that are able to resist extreme temperatures could be used.

Further advantages and improvements may very well be made to the present invention without deviating from its scope. Although the invention has been shown and described in what is conceived to be the most practical and preferred embodiment, it is recognized that departures may be made therefrom within the scope and spirit of the invention.

Any discussion of the prior art throughout the specification should in no way be considered as an admission that such prior art is widely known or forms part of the common general knowledge in this field.

In the summary of the invention and the claims that follow, except where the context requires otherwise due to express language or necessary implication, the word “comprising” is used in the sense of “including”, i.e. the features specified may be associated with further features in various embodiments of the invention.

1. A method of producing a filter membrane wherein at least two layers are sequentially built upon a forming member such that, when the forming member is removed, the resultant membrane includes a plurality of apertures extending therethrough, and at least some of said apertures increase in cross-sectional area from a first surface of the membrane to a second surface of the membrane, at least one of said layers is formed by partially submersing the forming member into a mixture containing, in part, metallic particulate.

2. (canceled)

3. A method according to claim 1 wherein the mixture includes a base material such as N-metal, priodyne, ethylene, glycol or similar and further including a metal base powder, such as but not limited to, stainless steel, tungsten, silica, boron, cobalt, chromium, nickel, and/or silver nitride.

4. A method according to claim 1 wherein the mixture is blended into homogenous consistency at a constant temperature.

5. A method according to claim 1 wherein the mixture is heated to a temperature ranging from 38° C. to 110° C. and constantly stirred for a period of between 2 and 24 hours.

6. A method according to claim 1 wherein the mixture includes a methanol based solution including 1000 ml of denatured alcohol, 10 grams to 20 grams of Teflon, 7 grams of wax, 2 ml to 9 ml of glycerine and 2 m to 7 ml of polyethylene glycol, which is mixed with a metallic powder to produce a mixture having a paint-like constancy.

7. (canceled)

8. A method according to claim 1 wherein the forming member is immersed in a sequence of different mixtures to form a plurality of layers.

9. A method according to claim 1 wherein the different mixtures contain particles of different grain size having different melting points.

10. (canceled)

11. A method according to claim 1 wherein the forming member comprises a chromed and highly polished rod with a diameter of between 4 mm and 300 mm.

12. A method according to claim 1 wherein a charge is applied to the forming member to assist in the formation of said at least two layers.

13. A method of producing a multilayered filter membrane, including the steps of:
a. providing a rod, which is adapted to act as a forming member onto which the membrane is built;
b. immersing at least a portion of the rod in a first mixture containing a first metallic particulate and a methanol based solution, whereby a first layer is formed;
c. removing the rod from the first mixture and allowing it to drip in a controlled atmosphere for a first pre-determined period of time;
d. immersing the rod into a liquid and allowing the rod to stand for a second pre-determined period of time;
e. allowing the rod to stand for a third predetermined period of time;
f. drying the rod; g. placing the rod into a sheath such that a the rod is separated from the sheath by a cavity;
h. filling the cavity with a second mixture containing a second metallic particulate;
i. sealing the ends of the sheath;
j. placing the sheathed rod into a press and applying a known pressure to the rod and coating thereby forming a cast;
k. separating the cast from the rod; and
l. treatment of the cast to thereby form a metallic filter membrane.

14. (canceled)

15. A method according to claim 13 wherein the treatment involves sintering the cast in a furnace.

16. A method according to claim 13 wherein steps b. to f. are repeated at least twice such that the rod is sequentially immersing into a plurality of mixtures containing particulates of different diameters.

17. A method according to claim 13 wherein the first pre-determined time period is in the range from 5 seconds to 3 minutes and wherein the second pre-determined time period is in the range from 30 seconds to 3 minutes and wherein the third pre-determined time period is in the range between 3 seconds and 1 hour.

18. (canceled)

19. (canceled)

20. A method according to claim 13 wherein the liquid is RO water which is kept at a constant temperature.

21. A method according to claim 13 wherein the rod is dried, either by air or infrared radiation.

22. A method according to claim 13 wherein the pressure applied is between 15,000 psi and 45,000 psi.

23. A method according to claim 13 wherein the rod which is partially encased by the cast or coating assembly is left under pressure for up to 1 hour.

24. A method according to claim 13 wherein the cast is separated from the rod by withdrawing the rod out from within the cast assembly.

25. (canceled)

26. (canceled)

27. A method according to claim 3 wherein the mixture is blended into homogenous consistency at a constant temperature.

28. A method according to claim 3 wherein the mixture is heated to a temperature ranging from 38° C. to 110° C. and constantly stirred for a period of between 2 and 24 hours.
